(19) United States
(12) Patent Application Publication
(10) Pub. No.: US 2012/0103998 A1
(43) Pub. Date: May 3, 2012

(54) Pan with Gripping Indentations on the Handle

(75) Inventors: Norton Sarnoff, Northbrook, IL (US); Raj Patel, Lake Zurich, IL (US)

(73) Assignee: HANDI-FOIL CORPORATION, Wheeling, IL (US)

(21) Appl. No.: 13/005,898

(22) Filed: Jan. 13, 2011

Related U.S. Application Data
(63) Continuation-in-part of application No. 29/377,966, filed on Oct. 28, 2010.
Application No. 29/377,966 is a continuation-in-part of application No. 29/377,967, filed on Oct. 28, 2010, now Pat. No. D633333.

(51) Int. Cl. A47J 37/10

(52) U.S. Cl. 220/573.1

(57) ABSTRACT

In summary there is provided in one embodiment a pan having a bottom base having a base periphery edge, a sidewall extending upwardly from the base periphery edge and terminating at a side edge to create a well therebetween, an outwardly extending ridge being an extension from the sidewall edge, the ridge having at least two opposing portions extending from the sidewall at a length to define a pair of opposing handles, a circular rim extending along the periphery of the ridge, and, at least one pair of gripping members separately positioned in each handle, the gripping members being defined to include an indentation with a lowered section extending below a lower surface defined by the periphery of the ridge, such that the lowered section is visible from a side of the pan.

### FIELD OF THE INVENTION

The present invention relates to pans and more particularly to a baking and roasting pans having handles with indentations for gripping.

### BACKGROUND OF THE INVENTION

Baking and roasting pans otherwise referred to herein generally as pans, have long been used to cook food in ovens. The pans will become hot in the over requiring the person to use oven mitts, gloves, or hand towels to avoid burning themselves, generally referred to herein as oven towel. And while most pans have handles extending out from the pan the user may still have a difficult time gripping the pan properly. Since the over towel can be heavily padded or bulky in order to protect the person's hands, the individuals grip will be decreased. Therefore, there is a continuing need to improve upon the pans to help increase a person's grip on the pan.

### SUMMARY OF THE INVENTION

In accordance with the present invention there is provided in one embodiment a pan having a bottom base with a base periphery edge. A sidewall extends upwardly from the base periphery edge and terminates at a side edge to create a well therebetween. An outwardly extending ridge extends from the sidewall edge. The ridge is provided with having at least two opposing portions extending from the sidewall at a length to define a pair of opposing handles. A gripping member is then positioned in each handle. Each gripping member is defined to include an indentation with a lowered section extending below a lower surface defined by the periphery of the ridge, such that the lowered section is visible from a side of the pan. In various embodiments, the lowered section extends between 0.75 to 0.125 inches below the lower surface of the ridge, the indentation extends along the ridge for about 2 inches, and/or the indentation extends along the ridge for a length defined as a ratio of 2.5 of the total length of a side of the pan. In yet other aspects, the pan further includes a circular rim extending along the periphery of the ridge.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of a pan in accordance with one embodiment of the present invention;

FIG. 2 is a side view of the pan from FIG. 1;

FIG. 3 is a front view of the pan from FIG. 1;

FIG. 4A is a top view of the pan from FIG. 1;

FIG. 4B is a side view of the pan from FIGS. 1; and

FIG. 5 is a perspective view of a pan in accordance with another embodiment.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

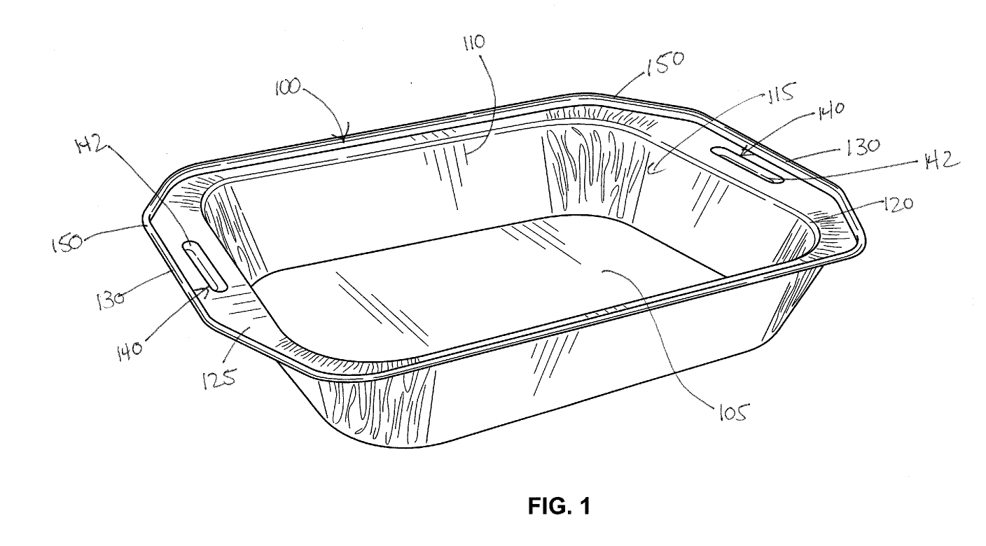

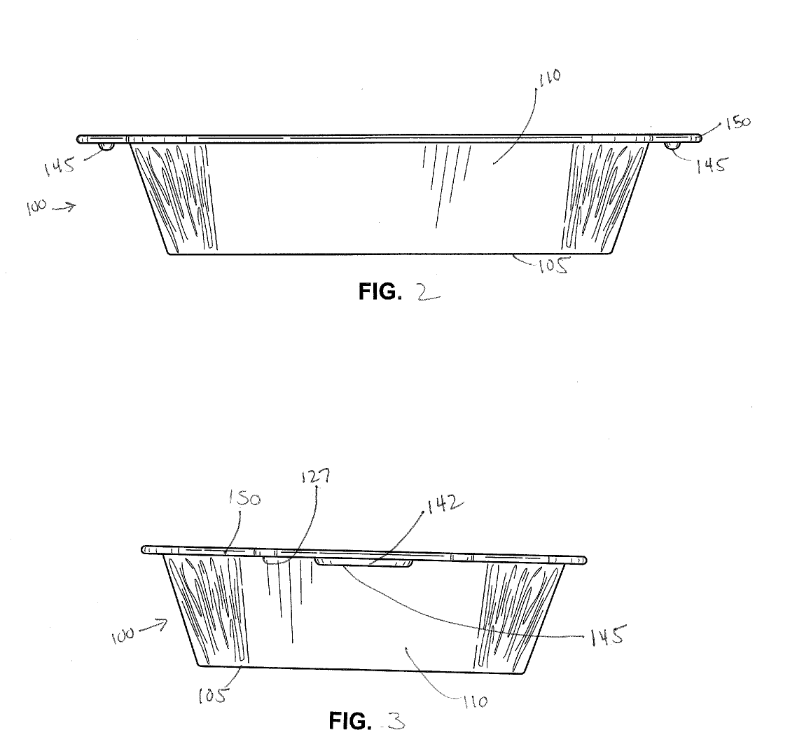

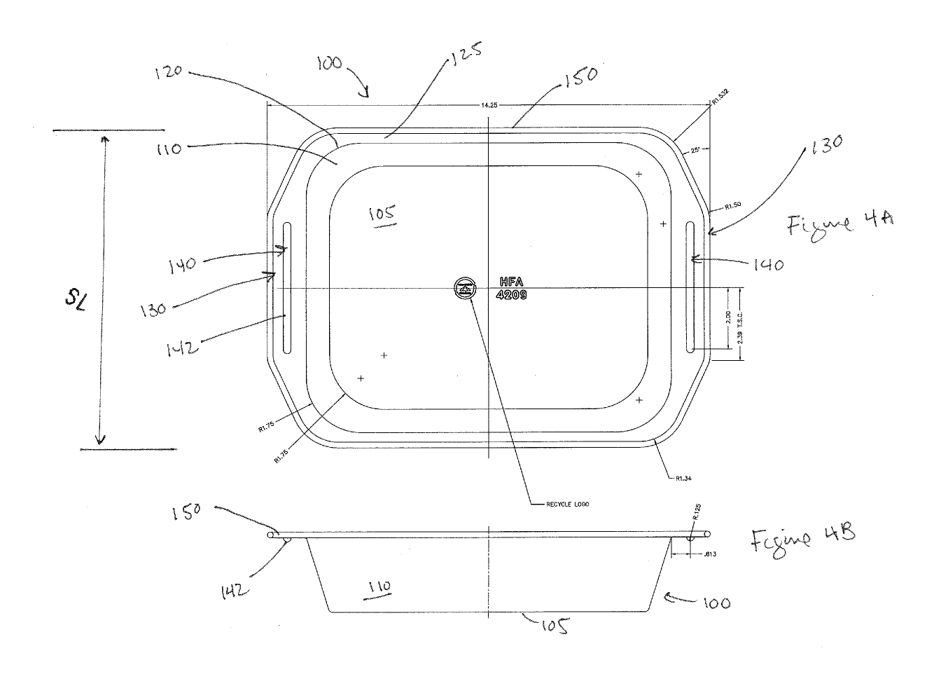

With reference to FIGS. 1-4B there is provided a pan 100, used for baking, roasting, or simply used for preparing and storing meals. The pan 100 can also be used for serving foods as well. The pan 100 includes a bottom base 105 terminated to an bottom edge that meets with a sidewall 110. The sidewall may be a single continuous sidewall or be sectioned into various sides (i.e. front, rear, left, right, or angled sides). Therefore the shape of the pan may be changed into various geometrically shapes, such as but not limited to a square, rectangular, circular, or other symmetrical polygonal shape. The sidewall 110 extends upwardly forming a depression or well 115 for which food can be placed. The sidewall 110 terminates at an edge 120 where it meets and forms into an outwardly extending ridge 125 that substantially surrounds the entire bottom base 105. The ridge 125 may have a length away from the sidewall that is uniformally dimensioned around the entire sidewall or it may extend further about a pair of opposing sides or edges of the pan 100 to form elongated handles 130.

As mentioned previously, the difficulties in the actual field of use is the handling of the prior art pans. In prior art pans the handles are simply smooth or pocketed with tiny dimples. Neither of which offers much support for actually gripping the pan especially when the pan is hot and the user is wearing or using an over towel.

To overcome the problems in the prior art, the pan 100 includes at least one gripping member 140 positioned in each handle 130. The gripping member 140 is defined as an indentation 142 in the handle 130. The indentation 142 has thus a lowered section 145 that extends below a lower surface 127 of the ridge 125, making the indentation 142 visible from the side or from the front or rear of the pan. In one embodiment the lowered section 145 of the indentation extends between 0.75 to 0.125 inches below the lower surface 127 of the ridge 125, and more preferably 0.125 inches below. In another embodiment the indentation has an accurate internal surface structure to help provide a grip from the top surface and lower surface of the ridge. In addition, the indentation 142 may extend along the ridge for 2 to 6 inches, and more preferably 4 inches or extend at a length defined by a ratio of 2.5 when compared to the entire side length SL.

In addition, the ridge 125 can further include an upstanding circular rim 150 extending along the entire periphery of the ridge 155. The rim 150 may typically have a diameter of 0.19 inches but may be enlarged to match the below extension of the indentation. This further provides opposing gripping portions to help enhance the person's handling of the pan.

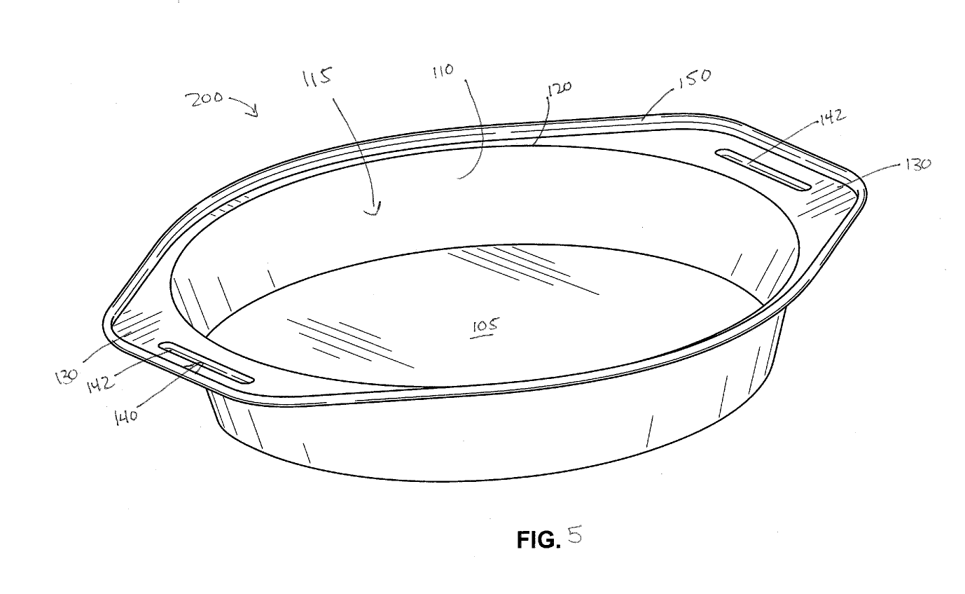

Referring now to FIG. 5, there is shown a circular pan 200 with similar features as described above with reference to similar numerals to indicate the same components.

It is further discussed herein that the indentations in the handle provide added strength to the handles {RAJ—please provide further reasoning as to why added strength is seen with the indentations}

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A pan comprising:
a bottom base having a base periphery edge;
a sidewall extending upwardly from the base periphery edge and terminating at a side edge to create a well therebetween;
an outwardly extending ridge being an extension from the sidewall edge, the ridge having at least two opposing portions extending from the sidewall at a length to define a pair of opposing handles;
a circular rim extending along a periphery of the ridge; and
at least one pair of gripping members separately positioned in each handle, the gripping members being defined to include an indentation with a lowered section extending below a lower surface defined by the periphery of the ridge, such that the lowered section is visible from a side of the pan.

2. The pan of claim 1, wherein the lowered section extends between 0.75 to 0.125 inches below the lower surface of the ridge.

3. The pan of claim 1, wherein the indentation extends along the ridge for about 2 inches.

4. The pan of claim 1, wherein the indentation extends along the ridge for a length defined as a ratio of 2.5 of the total length of a side of the pan.

5. A pan comprising:
a bottom base having a base periphery edge;
a sidewall extending upwardly from the base periphery edge and terminating at a side edge to create a well therebetween;
an outwardly extending ridge being an extension from the sidewall edge, the ridge having at least two opposing portions extending from the sidewall at a length to define a pair of opposing handles;
a gripping member positioned in each handle, each gripping member being defined to include an indentation with a lowered section extending below a lower surface defined by the periphery of the ridge, such that the lowered section is visible from a side of the pan.

6. The pan of claim 5, wherein the lowered section extends between 0.75 to 0.125 inches below the lower surface of the ridge.

7. The pan of claim 6, wherein the indentation extends along the ridge for about 2 inches.

8. The pan of claim 5, wherein the indentation extends along the ridge for a length defined as a ratio of 2.5 of the total length of a side of the pan.

9. The pan of claim 6 further comprising a circular rim extending along the periphery of the ridge.

10. A pan having a bottom base having a base periphery edge, a sidewall extending upwardly from the base periphery edge and terminating at a side edge to create a well therebetween, and an outwardly extending ridge being an extension from the sidewall edge, the ridge having at least two opposing portions extending from the sidewall at a length to define a pair of opposing handles, the improvement comprising:
a circular rim extending along the periphery of the ridge; and
at least one pair of gripping members separately positioned in each handle, the gripping members being defined to include an indentation with a lowered section extending below a lower surface defined by the periphery of the ridge, such that the lowered section is visible from a side of the pan.

11. The pan of claim 10, wherein the lowered section extends between 0.75 to 0.125 inches below the lower surface of the ridge.

12. The pan of claim 10, wherein the indentation extends along the ridge for about 2 inches.

13. The pan of claim 10, wherein the indentation extends along the ridge for a length defined as a ratio of 2.5 of the total length of a side of the pan.
